(19) United States
(12) Patent Application Publication
(10) Pub. No.: US 2016/0118807 A1
(43) Pub. Date: Apr. 28, 2016

(54) APPARATUS AND METHOD OF RECEIVING POWER WIRELESSLY, AND SYSTEM FOR SUPPLYING POWER WIRELESSLY USING THE SAME

(71) Applicant: SAMSUNG ELECTRO-MECHANICS CO., LTD, Suwon-si (KR)

(72) Inventors: Sang Ho CHO, Suwon-si (KR); Hyung Wook CHO, Suwon-si (KR); Sung Heum PARK, Suwon-si (KR); Chang Mok HAN, Suwon-si (KR); Jae Suk SUNG, Suwon-si (KR); Jeong Man HAN, Suwon-si (KR); Ki Won CHANG, Suwon-si (KR)

(73) Assignee: SAMSUNG ELECTRO-MECHANICS CO., LTD., Suwon-si (KR)

(21) Appl. No.: 14/656,077

(22) Filed: Mar. 12, 2015

(30) Foreign Application Priority Data
Oct. 27, 2014 (KR) 10-2014-0146154

(51) Int. Cl. H02J 5/00; H02J 7/02

(52) U.S. Cl. CPC H02J 5/005; H02J 7/025

(57) ABSTRACT

There are provided an apparatus and a method of receiving power wirelessly, and a system for supplying power wirelessly using the same. The apparatus for receiving power wirelessly may include a power receiving unit receiving power wirelessly in a non-contact manner, a switching unit operating the power receiving unit, and a controlling unit controlling an output voltage by adjusting an OFF switching operation of the switching unit.

### CROSS-REFERENCE TO RELATED APPLICATION

This application claims priority to, and the benefit of, Korean Patent Application No. 10-2014-0146154 filed on Oct. 27, 2014, with the Korean Intellectual Property Office, the disclosure of which is incorporated herein by reference.

### BACKGROUND

The present disclosure relates to an apparatus and a method of receiving power wirelessly, and a system for supplying power wirelessly using the same.

In accordance with a development of wireless technology, various functions, from the transmission of data to the transmission of power, are able to be performed wirelessly. Recently, technology for transmitting power wirelessly capable of charging an electronic device in a non-contact manner has come to prominence.

Such technology for transmitting power wirelessly may freely allow for charging an electronic device without a physical connection between the electronic device and charging device. Therefore, since convenience in charging an electronic device and a degree of spatial freedom are enhanced in the wireless power transmission technology, various applications have been made for the technology for transmitting power wirelessly.

However, a structure of an apparatus for transmitting power wirelessly or an apparatus for receiving power wirelessly may be relatively complex in order to satisfy the voltage requirements of various electronic devices, and as a result, efficiency of power transmissions may be decreased.

Patent Documents 1 to 6 listed below relate to art associated with apparatuses and methods for receiving power wirelessly.

[Related Art Document]

(Patent Document 1) Korean Patent Application No. 2011-0116025

(Patent Document 2) Korean Patent Application No. 2011-0051919

### SUMMARY

An aspect of the present disclosure may provide an apparatus and a method of receiving power wirelessly capable of adjusting an output voltage with a simple circuit configuration, and a system for supplying power wirelessly using the same.

According to an aspect of the present disclosure, an apparatus for receiving power wirelessly may include a power receiving unit receiving power wirelessly in a non-contact manner, a switching unit operating the power receiving unit, and a controlling unit controlling an output voltage by adjusting an OFF switching operation of the switching unit.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a configuration diagram illustrating a system for transmitting power wirelessly of according to an exemplary embodiment of the present disclosure;

FIG. 2 is a circuit diagram illustrating an example of an apparatus for transmitting power wirelessly according to an exemplary embodiment of the present disclosure;

FIG. 3 is a block diagram illustrating an example of an apparatus for receiving power wirelessly according to an exemplary embodiment of the present disclosure;

FIG. 4 is a block diagram illustrating an example of a controlling unit of FIG. 3;

FIG. 5 is a circuit diagram illustrating an example of the apparatus for receiving power wirelessly according to the exemplary embodiment of the present disclosure;

FIGS. 6A through 6C are graphs illustrating a level of a current depending on a switching timing;

FIG. 7 is a flowchart illustrating an example of a method of receiving power wirelessly according to an exemplary embodiment of the present disclosure; and

FIG. 8 is a flowchart illustrating an example of S720 of FIG. 7.

### DETAILED DESCRIPTION

Exemplary embodiments of the present disclosure will now be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements May be exaggerated for clarity, and the same reference numerals will be used throughout to designate the same or like elements.

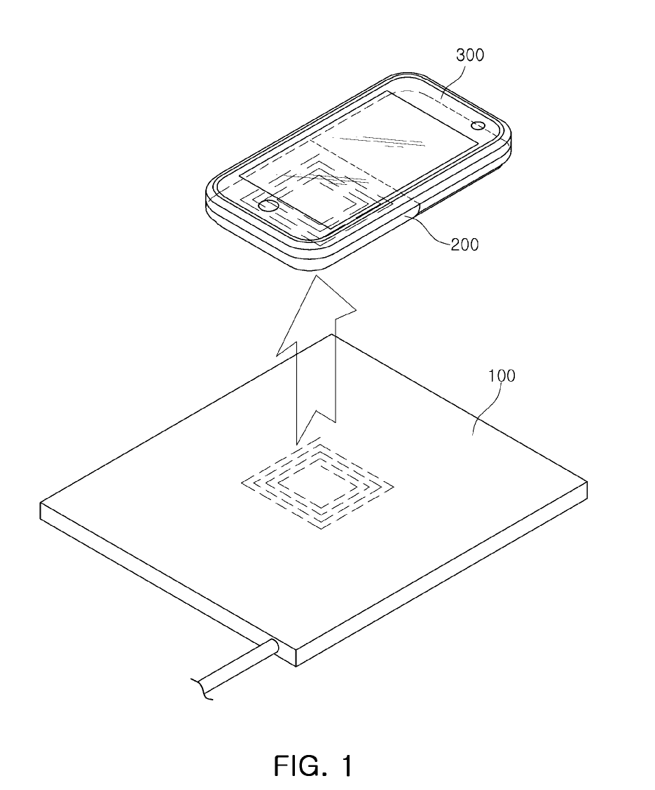

FIG. 1 is a configuration diagram illustrating a system for transmitting power wirelessly of according to an exemplary embodiment of the present disclosure.

As illustrated in FIG. 1, a system for transmitting power wirelessly of may include an apparatus 100 for transmitting power wirelessly and an apparatus 200 for receiving power wirelessly.

The apparatus 100 for transmitting power wirelessly may wirelessly transmit power to the apparatus 200 for receiving power wirelessly in a non-contact manner. The apparatus 100 for transmitting power wirelessly may include a transmit coil, wherein the transmit coil may resonate with a receiving coil of the apparatus 200 for receiving power wirelessly so as to wirelessly transmit power to the receiving coil.

Although the illustrated example illustrates one transmit coil, it is merely illustrative. For example, the apparatus 100 for transmitting power wirelessly may also include a plurality of transmitting coils.

According to an exemplary embodiment of the present disclosure, the apparatus 100 for transmitting power wirelessly may be operated regardless of the apparatus 200 for receiving power wirelessly. For example, the apparatus 100 for transmitting power wirelessly may be operated at a fixed frequency. That is, the apparatus 100 for transmitting power wirelessly 100 may wirelessly transmit power at the fixed frequency regardless of the kind and number of the apparatuses 200 for receiving power wirelessly. In the above-mentioned exemplary embodiment, the apparatus 200 for receiving power wirelessly may control an output voltage. That is, since the apparatus 100 for transmitting power wirelessly does not perform an operation for controlling the output voltage, a particular control is not required for the apparatus 100 for transmitting power wirelessly even in the case in which the apparatus 100 for transmitting power wirelessly simultaneously, wirelessly transmits power to a plurality of apparatuses 200 for receiving power wirelessly, such that a configuration and an operation thereof may be simplified.

The apparatus 200 for receiving power wirelessly may wirelessly receive the power supplied from the apparatus 100 for transmitting power wirelessly in the non-contact manner. The apparatus 200 for receiving power wirelessly may supply the wirelessly received power to an electronic device 300.

The apparatus 200 for receiving power wirelessly may adjust the output voltage by adjusting a resonance end timing using the apparatus 100 for transmitting power wirelessly. That is, the apparatus 200 for receiving power wirelessly may perform a predetermined operation for adjusting the output voltage. Therefore, the apparatus 100 for transmitting power wirelessly may be operated regardless of the number of apparatuses 200 for receiving power wirelessly or the output voltage thereof.

The apparatus 100 for transmitting power wirelessly and the apparatus 200 for receiving power wirelessly are not limited to a specific standard. For example, the apparatus 100 for transmitting power wirelessly and the apparatus 200 for receiving power wirelessly may also be operated while communications scheme at the time of wirelessly charging thereof satisfies a preset standard (e.g., A4WP). As another example, the apparatus 100 for transmitting power wirelessly and the apparatus 200 for receiving power wirelessly may also be operated while a preset communications scheme at the time of wirelessly charging thereof satisfies non-existing standards (e.g., WPC, PMA).

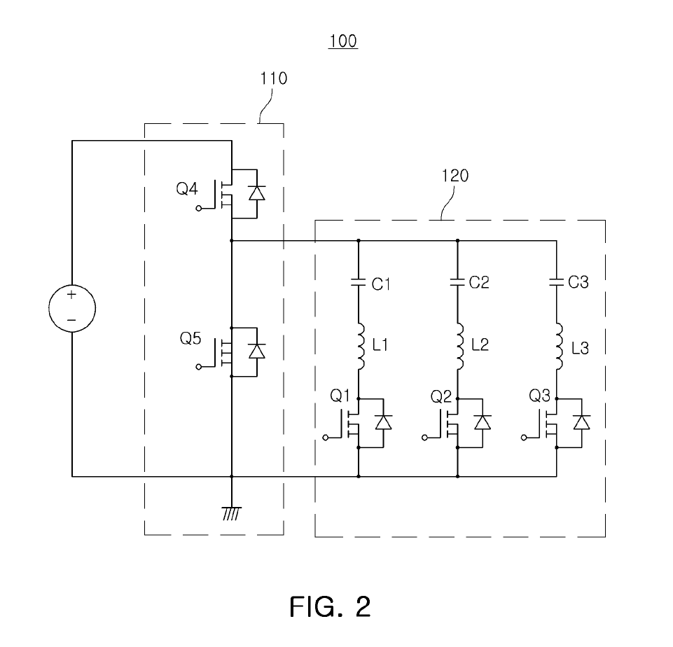

FIG. 2 is a circuit diagram illustrating an example of an apparatus for transmitting power wirelessly according to an exemplary embodiment of the present disclosure.

Referring to FIG. 2, an apparatus 100 for transmitting power wirelessly may include a switching unit 110 and a resonance tank 120.

The switching unit 110 may perform a switching operation regardless of the number of apparatuses 200 for receiving power wirelessly or the output voltage thereof. For example, switches Q4 and Q5 of the switching unit 110 may alternately perform the switching operation at a fixed frequency.

The resonance tank 120 may include transmitting coils L1, L2, and L3. Although the illustrated example illustrates an LC resonance tank, the resonance tank may be implemented as various resonance tanks such as an LLC resonance tank according to exemplary embodiments. Although the resonance tank 120 illustrates three transmitting coils in the illustrated example, this is merely illustrative, and the number of transmitting coils is not limited to the number mentioned above.

According to the related art, there is a scheme in which the apparatus 200 for receiving power wirelessly is operated at the fixed frequency and the apparatus 100 for transmitting power wirelessly varies a switching frequency depending on the output voltage. According to the above-mentioned scheme, when the power is wirelessly transmitted to the plurality of apparatuses 200 for receiving power wirelessly, the circuit may become complex and charging efficiency may be decreased.

Therefore, according to an exemplary embodiment of the present disclosure, the apparatus 100 for transmitting power wirelessly performs a constant operation and the apparatus 200 for receiving power wirelessly performs the adjustment depending on the output voltage, and consequently, the configurations of the apparatus 100 for transmitting power wirelessly and the apparatus 200 for receiving power wirelessly may be simplified and charging efficiency may be increased.

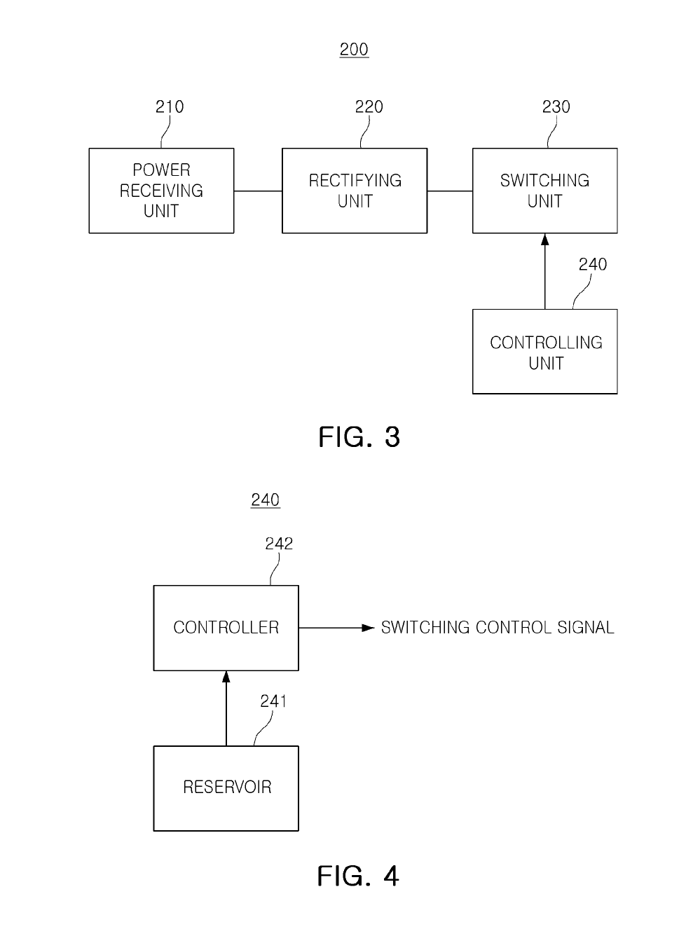

FIG. 3 is a block diagram illustrating an example of an apparatus for receiving power wirelessly according to an exemplary embodiment of the present disclosure.

The apparatus 200 for receiving power wirelessly may wirelessly receive the power in the non-contact manner. The apparatus 200 for receiving power wirelessly may adjust the output voltage by adjusting a resonance end timing using the apparatus 100 for transmitting power wirelessly.

The apparatus 200 for receiving power wirelessly may adjust a level of the output voltage by adjusting a resonance end timing of the resonance circuit.

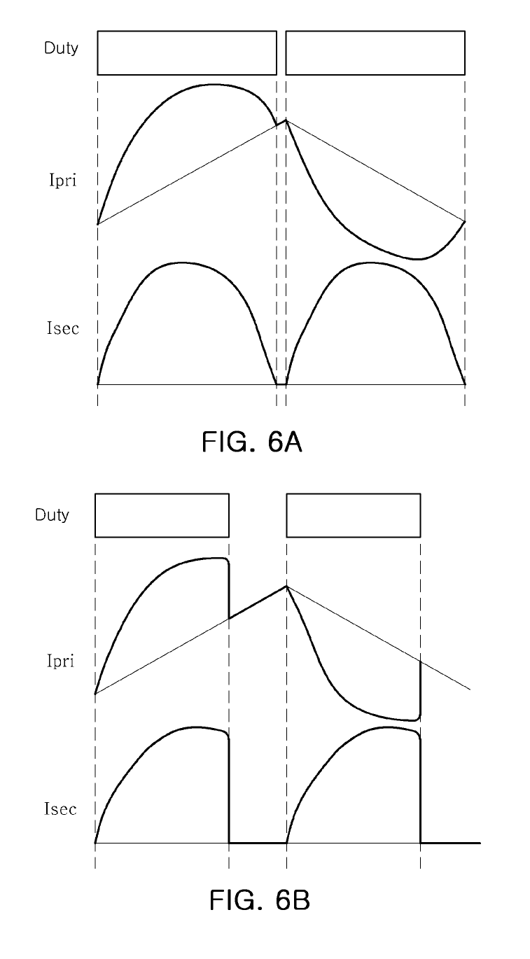

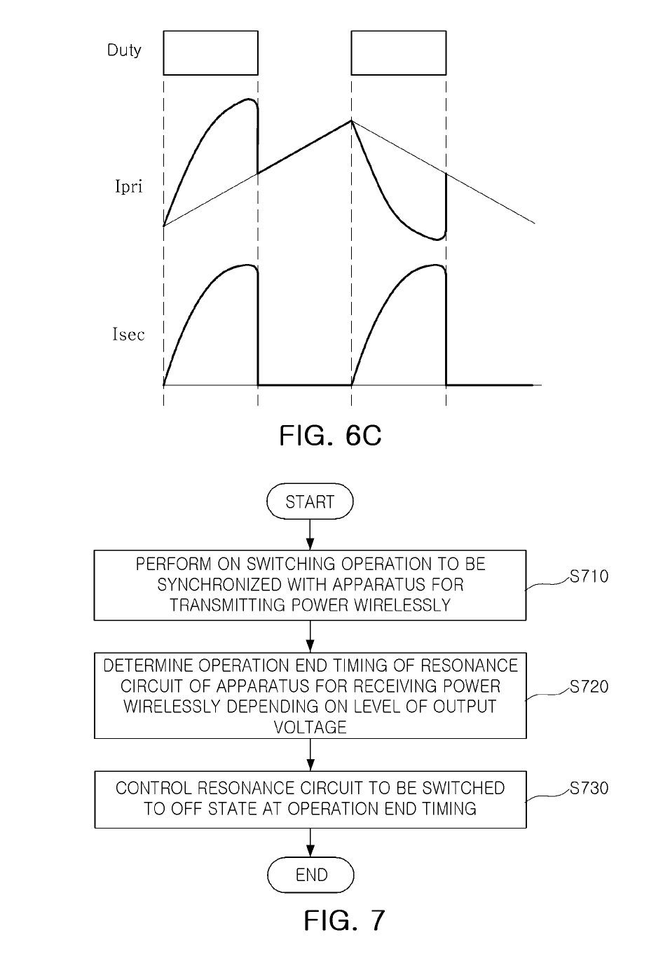

FIGS. 6A through 6C are graphs illustrating a level of a current depending on the switching timing. The adjustment of the output voltage of the apparatus 200 for receiving power wirelessly will be described with reference to FIGS. 6A through 6C.

Ipri illustrated in FIGS. 6A through 6C indicates a primary current, that is, a current of a transmit coil of the apparatus 100 for transmitting power wirelessly, and Isec indicates a secondary current, that is, a current of a receiving coil of the apparatus 200 for receiving power wirelessly. Here, an area by the receiving coil may correspond to the level of the output voltage.

Switching duties illustrated in FIGS. 6A through 6C relate to the switching operation of the apparatus 200 for receiving power wirelessly. As illustrated, it may be seen that the level of the output voltage according to the receiving coil may be changed depending on a switching OFF timing.

That is, it may be seen that as the switching OFF timing of the apparatus 200 for receiving power wirelessly is delayed, an amount of current Isec applied to the receiving coil is increased, and consequently, the level of the output voltage is increased.

As a result, the apparatus 100 for transmitting power wirelessly may be operated depending on a set operation, and the apparatus 200 for receiving power wirelessly may adjust the switching OFF timing in order to adjust the level of the output voltage. That is, the apparatus 200 for receiving power wirelessly may adjust the level of the output voltage by adjusting the switching OFF timing.

Referring to again FIG. 3, the apparatus 200 for receiving power wirelessly may include a power receiving unit 210, a switching unit 230, and a controlling unit 240.

According to an exemplary embodiment, the apparatus 200 for receiving power wirelessly may further include a rectifying unit 220.

The power receiving unit 210 may wirelessly receive the power in the non-contact manner. For example, the power receiving unit 210 may wirelessly receive the power in a magnetic resonance or magnetic induction type with the transmit coil.

The rectifying unit 220 may rectify the power which is wirelessly received by the power receiving unit 210.

The switching unit 230 may operate the power receiving unit 210. The switching unit 230 may be connected in series with the power receiving unit 210 so as to operate or stop the power receiving unit 210.

The controlling unit 240 may control the output voltage by adjusting an OFF switching operation of the switching unit 230.

According to an exemplary embodiment, the controlling unit 240 may control an ON switching operation of the switching unit 230 to be synchronized with an ON switching operation of the apparatus 100 for transmitting power wirelessly. That is, the controlling unit 240 may adjust the level of the output voltage by synchronizing the ON switching operation of the switching unit 230 with that of the apparatus 100 for transmitting power wirelessly and adjusting the OFF switching timing.

According to an exemplary embodiment, the controlling unit 240 may control the switching unit 230 so that a timing of the OFF switching operation of the switching unit 230 is retarded as the output voltage is increased. The reason is that as the OFF switching operation of the switching unit 230 is retarded, the amount of current Isec applied to the secondary receiving coil is increased and consequently, the level of the output voltage is increased, as described above with reference with FIG. 6.

FIG. 4 is a block diagram illustrating an example of the controlling unit of FIG. 3.

Referring to FIG. 4, the controlling unit 240 may include a reservoir 241 and a controller 242.

The reservoir 241 may maintain synchronization information with the apparatus 100 for transmitting power wirelessly. The reservoir 241 may store switching synchronization information of the apparatus 100 for transmitting power wirelessly. For example, the apparatus 100 for transmitting power wirelessly may perform a switching operation at a fixed frequency and the reservoir 241 may store the synchronization information on the fixed frequency.

The controller 242 may adjust the switching timing of the switching unit 230 using the synchronization information.

For example, the controller 242 may synchronize the ON switching operation of the switching unit 230 with the switching operation of the apparatus 100 for transmitting power wirelessly using the synchronization information. Then, the controller 242 may determine the OFF switching timing of the switching unit 230 according to the level of the output voltage.

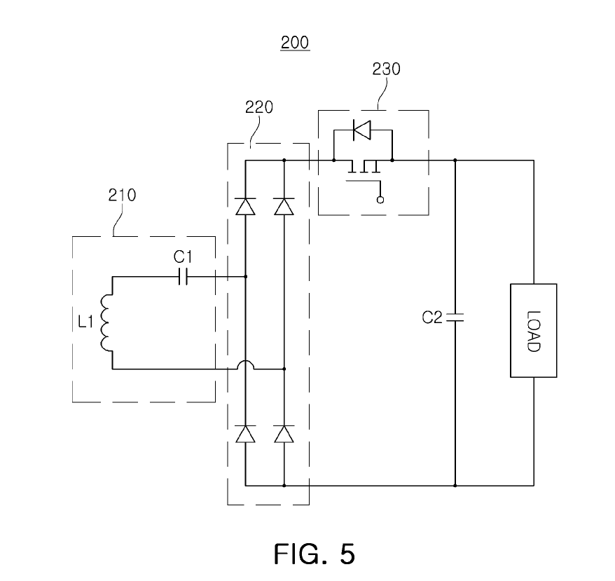

FIG. 5 is a circuit diagram illustrating an example of the apparatus for receiving power wirelessly according to the exemplary embodiment of the present disclosure.

Referring to FIG. 5, the apparatus 200 for receiving power wirelessly may include a resonance circuit 210, a rectifying circuit 220, and a switch 230. The resonance circuit 210, the rectifying circuit 220, and the switch 230 may correspond to the power receiving unit 210, the switching unit 230, and the controlling unit 240 of FIG. 3, respectively.

The resonance circuit 210 may include a receiving coil L1 and a capacitor C1.

The receiving coil L1 may wirelessly receive power in the non-contact manner. The capacitor C1 may block a direct current component of the power which is wirelessly received by the receiving coil L1.

Although the illustrated resonance circuit 210 is configured as an LC circuit, it may also be configured as an LLC circuit according to an exemplary embodiment as described above.

The switch 230 may be configured as a single switch which is connected in series with the resonance circuit 210. That is, the switch 230 may be configured as the single switch.

The reason is that since the level of the output voltage may be adjusted by determining the operation timing of the resonance circuit 210, the operation timing of the resonance circuit 210 may be determined only by an ON-OFF operation of the single switch. Therefore, the present disclosure may perform the control by the single switch without requiring a separate transforming circuit, or the like, whereby the output voltage may be adjusted by a simple and inexpensive circuit configuration.

FIG. 7 is a flowchart illustrating an example of a method of receiving power wirelessly according to an exemplary embodiment of the present disclosure. Since the method of receiving power wirelessly is performed in the apparatus for receiving power wirelessly described above with reference to FIGS. 1 through 6, a description that is the same as or corresponds to the above-mentioned description will be omitted.

Referring to FIG. 7, the apparatus 200 for receiving power wirelessly may be synchronized with the apparatus 100 for transmitting power wirelessly so as to perform the ON switching operation (S710).

The apparatus 200 for receiving power wirelessly may determine an operation end timing of the resonance circuit included in the apparatus 200 for receiving power wirelessly, depending on the level of the output voltage (S720).

The apparatus 200 for receiving power wirelessly may control the resonance circuit to be switched to an OFF state at the operation end timing.

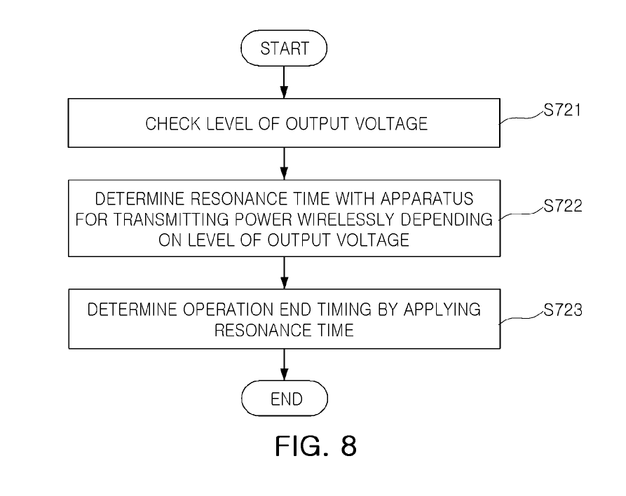

FIG. 8 is a flowchart illustrating an example of 5720 of FIG. 7.

Referring to FIG. 8, the apparatus 200 for receiving power wirelessly may check the level of the output voltage (S721).

The apparatus 200 for receiving power wirelessly may determine a resonance time with the apparatus for transmitting power wirelessly, depending on the level of the output voltage (S722).

The apparatus 200 for receiving power wirelessly may determine the operation end timing by applying the resonance time (S723).

As set forth above, according to exemplary embodiments of the present disclosure, the output voltage may be adjusted with the simple circuit configuration, whereby production costs may be reduced.

According to an exemplary embodiment of the present disclosure, since the apparatus for transmitting power wirelessly is operated regardless of the output voltage of the apparatus for receiving power wirelessly, it has a simple configuration, whereby production costs may be reduced.

According to an exemplary embodiment of the present disclosure, since the apparatus for receiving power wirelessly has the reduced number of active elements, heat characteristics may be improved and reliability may be improved.

While exemplary embodiments have been shown and described above, it will be apparent to those skilled in the art that modifications and variations could be made without departing from the scope of the present invention as defined by the appended claims.

What is claimed is:

1. An apparatus for receiving power wirelessly, the apparatus comprising:
a power receiving unit receiving power wirelessly in a non-contact manner;
a switching unit operating the power receiving unit; and
a controlling unit controlling an output voltage by adjusting an OFF switching operation of the switching unit.

2. The apparatus of claim 1, wherein the controlling unit controls an ON switching operation of the switching unit to be synchronized with an ON switching operation of an apparatus for transmitting power wirelessly.

3. The apparatus of claim 1, wherein the controlling unit controls a timing of the OFF switching operation to be retarded as the output voltage is increased.

4. The apparatus of claim 1, wherein the controlling unit includes:
a reservoir maintaining synchronization information with an apparatus for transmitting power wirelessly; and
a controller adjusting a switching timing using the synchronization information.

5. The apparatus of claim 1, wherein the power receiving unit includes:
a receiving coil receiving power wirelessly in the non-contact manner; and
a capacitor blocking a direct current component of the power wirelessly received by the receiving coil.

6. The apparatus of claim 1, further comprising a rectifying unit rectifying the power wirelessly received by the power receiving unit.

7. The apparatus of claim 6, wherein the switching unit is configured of a single switch connected to the rectifying unit in series.

8. A system for supplying power wirelessly, comprising:
an apparatus for transmitting power wirelessly, transmitting power wirelessly in a non-contact manner; and
an apparatus for receiving power wirelessly, receiving power wirelessly in the non-contact manner, and adjusting an output voltage by adjusting a resonance end timing using the apparatus for transmitting power wirelessly.

9. The system for supplying power wirelessly of claim 8, wherein the apparatus for transmitting power wirelessly is operated at a fixed frequency regardless of the output voltage of the apparatus for transmitting power wirelessly.

10. The system for supplying power wirelessly of claim 9, wherein the apparatus for receiving power wirelessly adjusts a level of the output voltage by adjusting a resonance end timing of a resonance circuit.

11. The system for supplying power wirelessly of claim 9, wherein the apparatus for receiving power wirelessly includes:
a power receiving unit receiving power wirelessly in the non-contact manner;
a switching unit operating the power receiving unit; and
a controlling unit controlling the output voltage by adjusting an OFF switching operation of the switching unit.

12. The system for supplying power wirelessly of claim 11, wherein the controlling unit controls an ON switching operation of the switching unit to be synchronized with an ON switching operation of an apparatus for transmitting power wirelessly.

13. The system for supplying power wirelessly of claim 11, wherein the controlling unit controls a timing of the OFF switching operation to be retarded as the output voltage is increased.

14. The system for supplying power wirelessly of claim 11, wherein the controlling unit includes:
a reservoir maintaining synchronization information with an apparatus for transmitting power wirelessly; and
a controller adjusting a switching timing using the synchronization information.

15. A method of receiving power wirelessly in an apparatus for receiving power wirelessly, the method comprising:
performing an ON switching operation to be synchronized with an apparatus for transmitting power wirelessly;
determining an operation end timing of a resonance circuit included in the apparatus for receiving power wirelessly, depending on a level of an output voltage; and
controlling the resonance circuit to be switched to an OFF state at the operation end timing of the resonance circuit.

16. The method of claim 15, wherein the determining of the operation end timing of the resonance circuit includes:
checking the level of the output voltage;
determining a resonance time with the apparatus for transmitting power wirelessly, depending on the level of the output voltage; and
determining the operation end timing by applying the resonance time.
